(19) United States
(12) Patent Application Publication
(10) Pub. No.: US 2022/0402170 A1
(43) Pub. Date: Dec. 22, 2022

(54) METHOD FOR IMPREGNATING A FIBROUS MATERIAL WITH AN OPTIMISED SYSTEM FOR RESUPPLYING AND CLEANING FINE PARTICLES

(71) Applicant: Arkema France, Colombes (FR)

(72) Inventors: Thibaut SAVART, Lacq (FR); Arthur Pierre BABEAU, Lacq (FR); Axel SALINIER, Lacq (FR); Denis HUZE, Serquigny (FR)

(73) Assignee: Arkema France, Colombes (FR)

(21) Appl. No.: 17/774,975

(22) PCT Filed: Nov. 5, 2020
(86) PCT No.: PCT/FR2020/051998

§ 371 Date: May 6, 2022

(30) Foreign Application Priority Data
Nov. 6, 2019 (FR) FR1912421

(51) Int. Cl. B29B 15/14; B29C 70/00; B29C 70/16; B29C 70/50

(52) U.S. Cl. CPC B29B 15/14; B29C 70/003; B29C 70/16; B29C 70/50; B29C 2791/003; B29K 2101/12

(57) ABSTRACT

A method for manufacturing an impregnated fibrous material comprising at least one fibrous material made of continuous fibres and at least one thermoplastic polymer matrix comprises a step of pre-impregnating the fibrous material with a thermoplastic polymer matrix in powder form. This step is carried out dry in a tank comprising a fluidized bed, while keeping the level h of the powder and the mass m of the powder present in the tank substantially constant. The level h is from hi to hi−3%, during implementation of the pre-impregnation step, and hi is the initial level of the powder in the tank at the start of implementation of the pre-impregnation step, the mass m is from mi to mi±0.5% during implementation of the pre-impregnation step, and mi is the initial mass of the powder in the tank at the start of implementation of the pre-impregnation step.

The present invention relates to a process for manufacturing an impregnated fibrous material comprising at least one fibrous material made of continuous fibers and at least one thermoplastic polymer matrix, said process comprising a step of pre-impregnating said fibrous material with a thermoplastic polymer matrix in powder form in a fluidized bed, the level h of the powder and the mass m of the powder present in the tank (20) being kept substantially constant in the tank (20) during the implementation of the pre-impregnation step.

In other words, said level h of the powder is from hᵢ to hᵢ−3%, in particular hᵢ−2%, during the implementation of the pre-impregnation step, hᵢ being the initial level of the powder in said tank (20) at the start of the implementation of the pre-impregnation step, said mass m being from mᵢ to mᵢ±0.5% during the implementation of the pre-impregnation step, mᵢ being the initial mass of the powder in said tank (20) at the start of the implementation of the pre-impregnation step.

In the present description, the expression “fibrous material” is understood to mean an assembly of reinforcing fibers. Before the shaping of said fibrous material, it is in the form of rovings. After the shaping thereof, it is in the form of ribbons (or tapes), strips or sheets. Their assembly constitutes a unidirectional reinforcement or a fabric or a nonwoven (NCF).

In the present description, the term “strip” is used to denote strips of fibrous material, the width of which is greater than or equal to 400 mm. The term “ribbon” is used to denote ribbons with a calibrated width of less than or equal to 400 mm.

The quality of impregnation with thermoplastic polymers, in particular of high viscosity, on reinforcing fibers to make thermoplastic pre-impregnated tapes requires perfect control of the amount of impregnated polymer and the quality of distribution of this polymer within the roving of reinforcing fibers during the impregnation process. Many patents or patent applications, for example WO2018/229114, WO 2018/234436, WO 2018/234439 and EP 2788408, describe the fact that the spreading of the fibers is an essential parameter for obtaining a homogeneous quality of polymer impregnation within the fibers on the final tape.

In general, the spreading of reinforcing fibers, such as carbon fibers, is generated via mechanical, pneumatic and/or vibratory systems. The main drawback of these methods is that of generating fiber misalignment within a roving (spreading by blow-out or suction) and/or mechanical degradation of the fibers by application of too high a transverse stress.

The generation of spreading, with any system whatsoever, can generate the breakage of fibers or at the very least a partial deterioration of these fibers. A kind of fluff of fibers called “fuzz” is then formed. This fuzz, generally consisting of several accumulated pieces of fiber, is generated mainly at the contact points between the fiber and an element of the impregnation line (guide fingers, support rollers, etc.). The greater the mechanical stresses applied, the more the fuzz tends to be created. A fuzz which is created and ends up accumulating in particular in the pre-impregnation bath is then observed over time. In a fluidized bed type pre-impregnation bath, the fuzz degrades the quality of fluidization locally and the quality of the fluidized bed continuously decreases. As a result, the level of the fluidized bed decreases and the local concentration of powder particles changes. A nonhomogeneous bath of powder which no longer makes it possible to correctly and constantly impregnate during the process is then observed. The amount of powder captured by the fiber roving, and therefore the amount of polymer impregnated in the tape, tends to decrease over time.

Caking of the powder particles which can appear in the blind spots and which does not come from the accumulation of the fuzz is also observed. It is well known to those skilled in the art that all the powders end up settling in the corners in particular of the tanks by loss of speed of the powders in contact with the walls of the tank, causing caking. In addition, due to contact between them and because of their geometry which is generally not perfectly spherical, the powders also end up agglomerating and therefore settling. This consequently has an overall impact on the height of the level of the powder in the tank and therefore reduces it.

Document FR2659595 describes a process for impregnating fibers by means of an aerosol supplied with powder by a fluidized bed comprising a system for reintroducing the particles previously introduced but not impregnated, the powder particles being intentionally electrostatically charged.

Document EP0246167 describes a process for impregnating fibers by means of an aerosol with the volume or weight of polymer carried away and of fibers being maintained at the value chosen beforehand.

Document WO2018/234436 describes an electrostatic process for impregnating fibers.

The particle sizes used in fluidized bed pre-impregnation processes for powders are generally centered on 100-200 μm, with a relatively large deviation (D10 and D90 far from D50) (see in particular the references WO2018115737A1 & WO2018115738A1). This dispersion is necessary to obtain a homogeneous and stable fluidization, and also an optimized quality of pre-impregnation. Due to the high disparity in size between the smallest particles (a few μm in diameter or fine particles) and the largest (up to 500-600 μm for example), fine particles fly away (more than 99% by volume of the powders that have flown away have a size between 0.01 μm and 60 μm) out of the fluidization tank (20). The flyaway of these fine particles leads to several major problems:

Depletion of the fluidized bed in terms of fine particles, which can cause a modification of the quality of pre-impregnation of the fiber roving and of the stability of the fluidization bath and also the level thereof,

Significant loss of material and therefore a drop in profitability of the manufacturing process. It would be preferable to be able to capture said fine particles and upgrade them,

QHSE (Quality, Health, Safety and Environment) issues caused by the flyaway of fine particles (<10 μm) for operators and equipment.

Similarly, during production, it is necessary to replenish the pre-impregnation tank (20) with a “stock solution” of composition equivalent to that initially introduced into the pre-impregnation bath. In a fluidized bed system, it is therefore necessary to maintain not only a constant powder height but also a constant powder mass in the fluidization tank (20) in order to obtain a product that is well impregnated and constant in terms of polymer content. The replenishment of the powder is generally done manually and periodically, inducing small but very present variations in the compositions of the bath during the production time.

It is therefore necessary to remedy the various problems listed above.

The present invention therefore relates to a process for manufacturing an impregnated fibrous material comprising at least one fibrous material made of continuous fibers and at least one thermoplastic polymer matrix, said process comprising a step of pre-impregnating said fibrous material with a thermoplastic polymer matrix in powder form, characterized in that said pre-impregnation step is carried out dry in a tank (20) comprising a fluidized bed (22), said pre-impregnation step being carried out while keeping the level h of the powder and the mass m of the powder present in the tank (20) substantially constant, said level h being from hᵢ to hᵢ−3%, in particular hᵢ−2%, during the implementation of the pre-impregnation step, where hᵢ is the initial level of the powder in said tank (20) at the start of the implementation of the pre-impregnation step, said mass m being from mᵢ to mᵢ±0.5% during the implementation of the pre-impregnation step, where mᵢ is the initial mass of the powder in said tank (20) at the start of the implementation of the pre-impregnation step.

The pre-impregnation step is carried out with the level h of the powder and the mass m being kept substantially constant, this being essential in the process of the invention.

Indeed, at the moment the pre-impregnation step is initiated, when the fluidization is started, there is an initial height hᵢ or an initial level of fluidizing powder in the tank (20) and also an initial mass mᵢ of powder in the tank (20).

During the implementation of the pre-impregnation step, both the level of the powder and the mass of powder present in the tank (20) must be kept substantially constant, that is to say that, in the tank (20) during the implementation of the pre-impregnation step, said level h must continuously be kept substantially constant; in other words, the level h must be from hᵢ to hᵢ−3%, in particular hᵢ−2%, where hᵢ is the initial level of the powder in said tank (20) at the start of the implementation of the pre-impregnation step, and the mass m of powder must continuously be kept substantially constant; in other words, said mass m must be from mᵢ to mᵢ±0.5% during the implementation of the pre-impregnation step, where mᵢ is the initial mass of the powder in said tank (20) at the start of the implementation of the pre-impregnation step.

The initial level of the powder hᵢ can be measured according to various techniques well known to those skilled in the art using fluidized beds of powders.

For example, it can be measured by means of a sensor, in particular a membrane-type position sensor, or by ultrasonic position measurement, for example sold by Flowline Inc. (USA) or even by laser measurement of the level of the fluidized bed in the tank, such as a laser displacement sensor sold by Keyence (France) or by continuous level measurement and level detection devices sold by Endress and Hauser (France).

If necessary, an average of measurements in the areas actually used to carry out the pre-impregnation of the fibers in the fluid bed can be carried out.

According to FR2659595 and EP0246167, a fluidized bed has a horizontal surface like a liquid in a container.

The initial level of the powder along the length and the width of the fluidized bed can therefore be easily measured.

Advantageously, the surface of the fluidized bed used in the invention is horizontal, in particular like a liquid in a container.

Advantageously, the height of the fluidized bed over the entire width and length of the tank is constant.

A constant mass of powder in the fluidized bed in order to maintain a constant pre-impregnation quality over time can be obtained using an automatic system for powder replenishment of the tank based on gravimetric metering devices connected to a balance on which the fluidization tank rests and to a fluidized bed level sensor. These metering devices continuously feed the fluidization tank in a non-useful area of the tank so as not to disturb the process.

Advantageously, the level h must be from hᵢ to hᵢ−2%, and the mass m must be from mᵢ to mᵢ±0.5% during the implementation of the pre-impregnation step.

In one embodiment, the volume mean diameter D50 of the thermoplastic polymer powder particles is from 30 to 300 μm, in particular from 50 to 200 μm, more particularly from 70 to 200 μm.

The volume diameters of the thermoplastic polymer powder particles (D10, D50 and D90) are defined according to the standard ISO 9276: 2014.

“D50” corresponds to the volume mean diameter, that is to say the value of the particle size which divides the population of particles examined exactly into two.

“D90” corresponds to the value at 90% of the combined curve of the volume particle size distribution.

“D10” corresponds to the size of 10% of the volume of the particles.

In one embodiment, the tank (20) is replenished with the thermoplastic polymer matrix in powder form to compensate for the consumption of said thermoplastic polymer matrix by the pre-impregnation of said fibrous material.

In one embodiment, the particle size of said powder is substantially constant in said tank (20), that is to say that the D50 varies by a maximum of +20%.

In another embodiment, the particle size of the fine particles of said powder is substantially constant in said tank (20), that is to say that the D10 varies by a maximum of +30%.

In yet another embodiment, the particle size of the large particles of said powder is substantially constant in said tank (20), that is to say that the D90 varies by a maximum of +10%.

Advantageously, the particle size of said powder is substantially constant in said tank (20), that is to say that the D50 varies by a maximum of +20% and the particle size of the fine particles of said powder is substantially constant in said tank (20), that is to say that the D10 varies by a maximum of +30%.

Advantageously, the particle size of said powder is substantially constant in said tank (20), that is to say that the D50 varies by a maximum of +20% and the particle size of the large particles of said powder is substantially constant in said tank (20), that is to say that the D90 varies by a maximum of +10%.

Advantageously, the particle size of the large particles of said powder is substantially constant in said tank (20), that is to say that the D90 varies by a maximum of +10% and the particle size of the fine particles of said powder is substantially constant in said tank (20), that is to say that the D10 varies by a maximum of +30%.

Advantageously, the particle size of said powder is substantially constant in said tank (20), that is to say that the D50 varies by a maximum of +20% and the particle size of the fine particles of said powder is substantially constant in said tank (20), that is to say that the D10 varies by a maximum of +30% and the particle size of the large particles of said powder is substantially constant in said tank (20), that is to say that the D90 varies by a maximum of +10%.

When the fibrous material enters the fluidized bed, the powder of the thermoplastic polymer matrix present in the tank (20) initially settles on the fibrous material and is therefore consumed during the pre-impregnation, which causes a drop in the powder level in the tank (20) and also a drop in the mass of powder present in the tank (20). It is therefore necessary to compensate for the level and the mass present in the tank (20) by introducing “stock composition”, that is to say initial thermoplastic polymer matrix in powder form, that is to say having the same D10, D50 and D90 characteristics.

However, with fluidization, fine particles initially present in the “stock composition” leave the fluidized bed and also the tank (20), thus causing the D50, D10 and D90 of the “stock composition” to vary even though the level and the mass present in the tank (20) are compensated for by introducing “stock composition” into the tank (20).

The D50 and/or the D90 and/or the D10 must therefore be kept constant.

In one embodiment, said tank (20) comprises a fluidized bed (22) and said pre-impregnation step is carried out with simultaneous spreading of said roving (81a) or of said rovings between the inlet and the outlet of said fluidized bed (22).

The term “spreading” denotes the factor by which the width of the fibrous material (or roving) increases relative to the initial width I of said roving, that is to say when said roving enters the system ensuring the pre-impregnation step. It is quite obvious that it is an average width (whether it is the initial width or the width after spreading out) of the roving, while flat, determined by averaging measurements obtained without contact (LASER, LED etc. . . . ) on several spools. The initial width does not necessarily correspond to the width of the roving at the outlet of the fibrous material supply reels.

In one embodiment, said tank (20) is equipped with a scraper.

As indicated above, the generation of a spreading out, with any system whatsoever, generates the breakage of fiber filaments: “fuzz” is then formed which accumulates over time, in particular in the pre-impregnation bath, degrading the quality of fluidization locally. The quality of the fluidized bed continuously decreases.

Furthermore, a caking of the powder particles themselves occurs, in particular in the dead areas of the fluidized bed. Due to both the fuzz and the “natural” caking of the powders, the level of the fluidized bed decreases overall and the local concentration of powder particles changes. Consequently, a scraper is needed to break up the accumulated powder blocks and thereby resuspend the powder particles.

In one embodiment, said scraper is used automatically when the level h<hᵢ−3%, in particular h<hᵢ−2%.

In order to obtain a substantially constant level of fluidized bed so as to maintain a substantially constant pre-impregnation quality over time, a scraper system is activated automatically and periodically when the threshold of the fluidized bed drops below a critical level. The purpose of this scraper is to expel the fuzz in an unused area of the fluidization tank but also to decake the powder accumulated in areas of the tank that are not very turbulent (caking phenomenon well known to those skilled in the art of fluidization). It can take several physical forms: pieces of independent fibers of a few mm or cm in length, a continuous fiber rolled up on itself thus forming a small ball, clusters of continuous short fibers in the form of a mass in suspension, clumps of agglomerated powder, etc. . . . .

In one embodiment, said tank (20) is equipped with a transverse suction system which sucks up fine particles having a diameter of 0.01 to 60 μm which leave said tank (20) during the fluidization.

Advantageously, 99% of the fine particles which leave said tank (20) during the fluidization have a diameter of from 0.01 to 60 μm.

The diameter of the particles which leave said tank can be measured by conventional techniques known to those skilled in the art (for example, LASER particle size measurement of the powders having flown away and been collected then analyzed over several production runs).

In another embodiment, said tank (20) is equipped with a transverse suction system which sucks up fine particles having a D50 of from 0.01 to 60 μm which leave said tank (20) during the fluidization.

Advantageously, said suctioned particles are continuously reintroduced into said tank (20).

In addition to the natural consumption of powder by the pre-impregnation step, the formation of fuzz, and the formation of clumps of agglomerated powder, fine particles of the “stock composition” fly away above the fluidization tank and will therefore cause a modification of the D50, D10 and D90 of the “stock composition”, this being despite the introduction of “stock composition”, which will disrupt the quality, the homogeneity and the amount of pre-impregnation of the fibrous material and also lower the level of the fluidized bed.

The fine particles consist of particles having a diameter from 0.01 to 60 μm.

Particles with a diameter of less than 0.01 μm do not initially exist in the system.

Particles with a diameter of greater than 60 μm do not generally fly away above the tank.

It is therefore necessary to recover the fine particles having a diameter of 0.01 to 60 μm which leave said tank (20) during the fluidization, which will then be reintroduced into the tank.

Advantageously, the transverse suction system is equipped with a selection grid to prevent particles larger than 60 μm from being sucked up and reintroduced into the tank.

The “stock composition” of powder added to the tank may also contain some of the particles recovered by the suction/recovery system depending on their particle size.

Advantageously, said tank (20) is equipped with a scraper and a transverse suction system which sucks up fine particles having a diameter of 0.01 to 60 μm which leave said tank (20).

Advantageously, 99% of the fine particles which leave said tank (20) during the fluidization have a diameter of from 0.01 to 60 μm.

Advantageously, said tank (20) is equipped with a scraper and a transverse suction system which sucks up fine particles having a D50 of from 0.01 to 60 μm which leave said tank (20).

Regarding the Pre-Impregnation Step

An example of a unit for implementing the manufacturing process is described in international application WO 2015/121583 and is represented in FIG. 1 with the exception of the tank (otherwise referred to as the pre-impregnation tank which in the case of the invention comprises a fluidized bed equipped with a tension device which may be a compression roller).

The pre-impregnation step and the tension devices can be as described in WO 2018/115737.

The compression roller may be fixed or rotary.

The step of pre-impregnation of the fibrous material is carried out by passing one or more rovings through a continuous pre-impregnation device, comprising a tank (20), comprising in particular a fluidized bed (22) of polymer powder.

The polymer powder or polymer is suspended in a gas G (air for example) introduced into the tank and flowing into the tank through a hopper 21. The roving(s) is (are) circulated through this fluidized bed 22.

The tank may have any shape, especially cylindrical or parallelepipedal, in particular a rectangular parallelepiped or a cube, advantageously a rectangular parallelepiped.

The tank can be an open or closed tank. Advantageously, it is open.

In the case where the tank is closed, it is then equipped with a sealing system so that the polymer powder cannot leave said tank.

This pre-impregnation step is therefore carried out by a dry route, that is to say that the thermoplastic polymer matrix is in powder form, especially in suspension in a gas, in particular air, but cannot be in dispersion in a solvent or in water.

Each roving to be pre-impregnated is unwound from a device (10) with reels (11) under the tension generated by rolls (not represented). Preferably, the device (10) comprises a plurality of reels (11), each reel making it possible to unwind one roving to be impregnated. Thus, it is possible to pre-impregnate several fiber rovings simultaneously. Each reel (11) is provided with a brake (not represented) so as to apply a tension to each fiber roving. In this case, an alignment module (12) makes it possible to position the fiber rovings parallel to one another. In this way, the fiber rovings cannot be in contact with one another, which makes it possible to prevent a mechanical degradation of the fibers by rubbing against themselves.

The fiber roving or parallel fiber rovings then pass through a tank (20), comprising in particular a fluidized bed (22), provided with a tension device that is a compression roller (23) in the case of FIG. 1. The fiber roving or parallel fiber rovings then emerge(s) from the tank after impregnation after controlling the residence time in the powder.

Controlling the residence time in the powder makes it possible to pre-impregnate the fibrous material with the thermoplastic polymer matrix, with a well-controlled content of resin and homogeneously.

The use of at least one tension device improves the impregnation compared to the prior art processes, in particular the impregnation is full impregnation.

A tension device is understood to mean any system on which the roving has the possibility of running through the tank. The tension device may have any shape as long as the roving can run on it.

This impregnation is carried out in order to enable the polymer powder to penetrate to the core of the fiber roving and to adhere to the fibers sufficiently to withstand the transport of the powder-coated roving out of the tank. The roving(s) pre-impregnated by the powder is (are) then sent to a heated calendering device, with the possibility of preheating before calendering and optional post-calendering heating.

Optionally, this pre-impregnation step may be completed by a step of covering the pre-impregnated roving or rovings, right at the outlet of the tank (20) for pre-impregnating with the powder in a fluidized bed (22), and right before the calendering shaping step. For this, the outlet airlock of the tank (20) (fluidized bed 22) may be connected to a covering device (30) that may comprise a covering crosshead, as is also described in patent EP 0 406 067. The covering polymer may be identical to or different from the fluidized bed polymer powder. Preferably, it is of the same type. Such coverage makes it possible not only to complete the step of pre-impregnating the fibers in order to obtain a final volume content of polymer within the desired range and avoid the presence, at the surface of the pre-impregnated roving, of a fiber content that is locally too high, which would be detrimental to the welding of the tapes during the manufacture of the composite part, especially for obtaining so-called “ready to use” fibrous materials of good quality, but also to improve the performance of the composite material obtained.

The process of the invention as indicated above is carried out by a dry route with exclusion of an electrostatic process with intentional charging.

The expression “with intentional charging” means that a potential difference is applied between the fibrous material and the powder. The charge is in particular controlled and amplified. The grains of powders then impregnate the fibrous material by attraction of the charged powder against the fiber. It is possible to electrically charge the powder, negatively or positively, by various means (potential difference between two metal electrodes, mechanical friction on metal parts, etc.) and to charge the fiber the opposite way (positively or negatively).

The process of the invention does not exclude the presence of electrostatic charges that might appear by friction of the fibrous material on the elements of the implementing unit before or in the tank but that are in any case unintentional charges.

Advantageously, the content of fibers in said impregnated fibrous material is from 45% to 65% by volume, preferably from 50% to 60% by volume, in particular from 54% to 60% by volume.

Below 45% of fibers, the reinforcement is insignificant as regards the mechanical properties.

Above 65%, the limits of the process are reached and the mechanical properties are lost again.

If the fibrous material, such as the glass fiber, has a size, an optional de-sizing step may be carried out before the fibrous material passes into the tank. The term “size” denotes surface treatments applied to the reinforcing fibers on leaving the spinneret (textile size) and to the woven fabrics (plastic size).

The “textile” size applied to the filaments, on leaving the spinneret, consists in depositing a binding agent ensuring the cohesion of the filaments to one another, reducing abrasion and facilitating subsequent handling operations (weaving, drape forming, knitting) and preventing the formation of electrostatic charges.

The “plastic” size or “finish” applied to the woven fabrics consists in depositing a bridging agent, the roles of which are to ensure a physicochemical bond between the fibers and the resin and to protect the fiber from its surroundings.

Advantageously, the content of fibers in said impregnated fibrous material is from 50% to 60% by volume, in particular from 54% to 60% by volume.

Advantageously, the residence time in the powder is from 0.01 s to 10 s, preferentially from 0.1 s to 5 s, and in particular from 0.1 s to 3 s.

The residence time of the fibrous material in the powder is essential for the impregnation, especially full impregnation, of said fibrous material.

Under 0.1 s, the impregnation is not right to the core.

Beyond 10 s, the amount of polymer matrix impregnating the fibrous material is too large and the mechanical properties of the pre-impregnated fibrous material will be poor.

Advantageously, the tank used in the process of the invention comprises a fluidized bed and said pre-impregnation step is carried out with simultaneous spreading of said roving or of said rovings between the inlet and the outlet of said fluidized bed.

The expression “inlet of the fluidized bed” corresponds to the vertical tangent of the edge of the tank which comprises the fluidized bed.

The expression “outlet of the fluidized bed” corresponds to the vertical tangent of the other edge of the tank which comprises the fluidized bed.

Depending on the geometry of the tank, the distance between the inlet and the outlet thereof therefore corresponds to the diameter in the case of a cylinder, to the side in the case of a cube or to the width or length in the case of a rectangular parallelepiped. The spreading consists in individualizing as much as possible each constituent filament of said roving from the other filaments that surround it in the closest space thereof. It corresponds to the transverse spreading of the roving.

In other words, the transverse spreading or the width of the roving increases between the inlet of the fluidized bed (or of the tank comprising the fluidized bed) and the outlet of the fluidized bed (or of the tank comprising the fluidized bed) and thus enables an improved impregnation, especially a full impregnation of the fibrous material.

The fluidized bed may be open or closed, in particular it is open.

Advantageously, the fluidized bed comprises at least one tension device, said roving or said rovings being in contact with a portion or the whole of the surface of said at least one tension device.

FIG. 2 gives details of a tank (20) comprising a fluidized bed (22) with a height-adjustable tension device (82).

The roving (81a) corresponds to the roving before impregnation which is in contact with a portion or the whole of the surface of said at least one tension device and therefore runs partially or completely over the surface of the tension device (82), said system (82) being immersed in the fluidized bed where the impregnation is carried out. Said roving then emerges from the tank (81b) after controlling the residence time in the powder.

Said roving (81a) may or may not be in contact with the edge of the tank (83a) which may be a rotary or fixed roller or a parallelepipedal edge.

Advantageously, said roving (81a) is optionally in contact with the edge of the tank (83a).

Advantageously, the edge of the tank (83b) is a roller, in particular a cylindrical and rotary roller.

Said roving (81b) may or may not be in contact with the edge of the tank (83b) which may be a roller, in particular a cylindrical and rotary or fixed roller, or a parallelepipedal edge.

Advantageously, said roving (81b) is in contact with the edge of the tank (83b).

Advantageously, the edge of the tank (83b) is a roller, in particular a cylindrical and rotary roller.

Advantageously, said roving (81a) is in contact with the edge of the tank (83a) and the edge of the tank (83b) is a roller, in particular a cylindrical and rotary roller and said roving (81b) is in contact with the edge of the tank (83b), and the edge of the tank (83b) is a roller, in particular a cylindrical and rotary roller.

Advantageously, said tension device is perpendicular to the direction of said roving or of said rovings.

Advantageously, said spreading of said roving or of said rovings is carried out at least level with said at least one tension device.

The spreading of the roving is therefore mainly carried out level with the tension device but may also be carried out level with the edge or edges of the tank if there is contact between the roving and said edge.

In another embodiment, said at least one tension device is a compression roller of convex, concave or cylindrical shape.

The convex shape is favorable to the spreading whereas the concave shape is unfavorable to the spreading although it is nevertheless carried out.

The expression “compression roller” means that the roving that is running presses partially or completely against the surface of said compression roller, which induces the spreading of said roving.

Advantageously, said at least one compression roller is of cylindrical shape and the percentage of spreading of said roving or of said rovings between the inlet and the outlet of said fluidized bed is from 1% to 400%, preferentially between 30% and 400%, preferentially between 30% and 150%, preferentially between 50% and 150%.

The spreading is a function of the fibrous material used. For example, the spreading of a carbon fiber material is much greater than that of a flax fiber.

The spreading is also a function of the number of fibers or filaments in the roving, of their mean diameter and of their cohesion by virtue of the size.

The diameter of said at least one compression roller is from 3 mm to 500 mm, preferentially from 10 mm to 100 mm, in particular from 20 mm to 60 mm.

Below 3 mm, the deformation of the fiber induced by the compression roller is too large.

Advantageously, the compression roller is cylindrical and non-grooved and in particular is metallic.

When the tension device is at least one compression roller, according to a first variant, a single compression roller is present in the fluidized bed and said impregnation is carried out at the angle α1 formed by said roving or said rovings between the start of said compression roller and the vertical tangent to said compression roller.

The angle α1 formed by said roving or said rovings between the start of said compression roller and the vertical tangent to said compression roller enables the formation of an area in which the powder will concentrate thus resulting in a “corner effect” which with the simultaneous spreading of the roving by said compression roller enables an impregnation over a greater roving width and therefore an improved impregnation compared to the prior art techniques. Coupling with the controlled residence time then enables a full impregnation.

Advantageously, the angle α1 is from 0 to 89°, preferentially 5° to 85°, preferentially from 5° to 45°, preferentially from 5° to 30°.

However, an angle α1 of from 0 to 5° is capable of generating risks of mechanical stress, which will result in the breakage of the fibers and an angle α1 of from 85° to 89° does not create enough mechanical stress to create “the corner effect”.

A value of the angle α1 equal to 0° therefore corresponds to a vertical fiber. It is quite obvious that the height of the cylindrical compression roller is adjustable thus making it possible to be able to position the fiber vertically.

It would not be outside the scope of the invention for the wall of the tank to be pierced so as to be able to allow the roving to leave.

Advantageously, the edge of the tank (83a) is equipped with a roller, in particular a cylindrical and rotary roller on which said roving or said rovings run(s) thus resulting in a prior spreading.

Advantageously, one or more tension devices are present downstream of the tank comprising the fluidized bed, on which tension device(s) the spreading is initiated.

Advantageously, the spreading is initiated on said tension device(s) defined above and continues on the edge of the tank (83a).

The spreading is then at a maximum after passing over the compression roller(s).

FIG. 2 describes an embodiment, without being limited thereto, having a single compression roller, with a tank (20) comprising a fluidized bed (22) in which a single cylindrical compression roller is present. The angle α1 is the angle formed between the vertical tangent of the compression roller and the roving which comes into contact with said roller.

The arrows on the fiber indicate the run direction of the fiber.

Advantageously, the level of said powder in said fluidized bed is at least located halfway up said compression roller.

It is quite obvious that the “corner effect” caused by the angle α1 favors the impregnation on one face but the spreading of said roving obtained by means of the compression roller also makes it possible to have an impregnation on the other face of said roving. In other words, said impregnation is favored on one face of said roving or of said rovings at the angle α1 formed by said roving or said rovings between the start of said at least one compression roller R1 and the vertical tangent to the compression roller R1 but the spreading also makes it possible to impregnate the other face.

The angle α1 is as defined above.

### Regarding the Fibrous Material

Regarding the fibers constituting said fibrous material, these are especially fibers of mineral, organic or plant origin. Mention may be made, among the fibers of mineral origin, of carbon fibers, glass fibers, silicon fibers, basalt or basalt-based fibers, or silica fibers, for example.

Among the fibers of organic origin, mention may be made of fibers based on a thermoplastic or thermosetting polymer, such as semiaromatic polyamide fibers, aramid fibers or polyolefin fibers for example.

Preferably, they are based on an amorphous thermoplastic polymer and have a glass transition temperature Tg above the Tg of the thermoplastic polymer or polymer blend constituting the pre-impregnation matrix when the latter is amorphous, or above the Tm of the thermoplastic polymer or polymer blend constituting the pre-impregnation matrix when the latter is semicrystalline. Advantageously, they are based on a semicrystalline thermoplastic polymer and have a melting temperature Tm above the Tg of the thermoplastic polymer or polymer blend constituting the pre-impregnation matrix when the latter is amorphous, or above the Tm of the thermoplastic polymer or polymer blend constituting the pre-impregnation matrix when the latter is semicrystalline. Thus, there is no risk of melting for the organic fibers constituting the fibrous material during impregnation by the thermoplastic matrix of the final composite.

Among the fibers of plant origin, mention may be made of natural fibers based on flax, hemp, lignin, bamboo, silk especially spider silk, sisal, and other cellulose fibers, in particular viscose fibers. These fibers of plant origin can be used pure, treated or else coated with a coating layer, for the purpose of facilitating the adhesion and impregnation of the thermoplastic polymer matrix.

The fibrous material may also be a fabric, braided or woven with fibers.

It may also correspond to fibers with support yarns.

These constituent fibers can be used alone or as mixtures. Thus, organic fibers can be mixed with mineral fibers in order to be pre-impregnated with thermoplastic polymer and form the pre-impregnated fibrous material.

Preferably the fibrous material is formed by continuous fibers of carbon, of glass or of silicon carbide or a mixture thereof, in particular carbon fibers. It is used in the form of a roving or several rovings.

In the impregnated materials that are also referred to as “ready to use” materials, the impregnating thermoplastic polymer or polymer blend is distributed uniformly and homogeneously around the fibers. In this type of material, the impregnating thermoplastic polymer must be distributed as homogeneously as possible within the fibers in order to obtain a minimum amount of porosities, i.e. a minimum amount of voids between the fibers. Specifically, the presence of porosities in materials of this type may act as points of stress concentrations, when placed under mechanical tensile stress for example, and which then form points of failure initiation of the impregnated fibrous material and mechanically weaken it. A homogeneous distribution of the polymer or polymer blend therefore improves the mechanical strength and the homogeneity of the composite material formed from these impregnated fibrous materials.

Thus, in the case of so-called “ready to use” impregnated materials, the content of fibers in said impregnated fibrous material is from 45% to 65% by volume, preferably from 50% to 60% by volume, especially from 54% to 60% by volume.

The measurement of the degree of impregnation may be carried out by image analysis (use of microscope or camera or digital camera, in particular) of a cross section of the ribbon, by dividing the surface area of the ribbon impregnated by the polymer by the total surface area of the product (impregnated surface area plus surface area of the porosities). In order to obtain a good quality image, it is preferable to coat the ribbon cut across its transverse direction with a standard polishing resin and to polish with a standard protocol enabling the observation of the sample with a microscope at at least six times magnification.

Advantageously, the degree of porosity of said impregnated fibrous material is less than 10%, notably less than 5%, in particular less than 2%.

It should be noted that a degree of porosity of zero is difficult to achieve and that consequently, advantageously, the degree of porosity is greater than 0% but less than the degrees mentioned above.

The degree of porosity corresponds to the degree of closed porosity and may be determined either by electron microscopy, or as being the relative deviation between the theoretical density and the experimental density of said impregnated fibrous material as described in the examples section of the present invention.

The fibers which may be part of the composition of the fibrous materials can have different linear basis weights or title or titration or “tex” and/or be in different numbers in the rovings. Thus, the most conventionally used rovings are composed of 600 to 4800 tex for glass fibers and 3000 (3K), 6000 (6K), 12 000 (12K), 24 000 (24K), 48 000 (48K), 50 000 (50K) or 400 000 (400K) fibers for carbon fibers. Carbon fibers generally have a diameter close to 7-8 μm and glass fibers a diameter of approximately 13, 15, 17 or 20 μm for example.

It is quite obvious that the spreading depends on the number of fibers present in the fibrous material or the roving.

Thus, for a 12K roving the spreading represents from 2 to 3 times the initial width I, for a 24K roving the spreading represents from 2 to 4 times the initial width I and for a 50K roving the spreading represents from 1.5 to 2.5 times the initial width I.

### Regarding the Thermoplastic Polymer of the Matrix

A thermoplastic, or thermoplastic polymer, is understood to mean a material that is generally solid at ambient temperature, which may be semicrystalline or amorphous, and which softens during an increase in temperature, in particular after passing its glass transition temperature (Tg), and flows at higher temperature when it is amorphous, or that may exhibit obvious melting on passing its melting temperature (Tm) when it is semicrystalline, and which becomes solid again during a reduction in temperature below its crystallization temperature (for a semicrystalline polymer) and below its glass transition temperature (for an amorphous polymer).

The Tg and Tm are determined by differential scanning calorimetry (DSC) according to the standards 11357-2: 2013 and 11357-3: 2013 respectively.

Regarding the polymer constituting the matrix for pre-impregnating the fibrous material, this is advantageously a thermoplastic polymer or a blend of thermoplastic polymers. This thermoplastic polymer or polymer blend can be ground in powder form, in order to be able to use it in a device such as a tank, in particular in a fluidized bed tank or in an aqueous dispersion.

The device in the form of a tank, in particular a fluidized bed tank, may be open or closed.

Optionally, the thermoplastic polymer or blend of thermoplastic polymers further comprises carbon-based fillers, in particular carbon black or carbon-based nanofillers, preferably chosen from carbon-based nanofillers, in particular graphenes and/or carbon nanotubes and/or carbon nanofibrils, or mixtures thereof. These fillers make it possible to conduct electricity and heat, and consequently make it possible to facilitate the melting of the polymer matrix when it is heated.

Optionally, said thermoplastic polymer comprises at least one additive, in particular chosen from a catalyst, an antioxidant, a heat stabilizer, a UV stabilizer, a light stabilizer, a lubricant, a filler, a plasticizer, a flame retardant, a nucleating agent, a chain extender and a dye, an electrically conductive agent, a thermally conductive agent, or a mixture of these.

Advantageously, said additive is chosen from a flame retardant, an electrically conductive agent and a thermally conductive agent.

According to another variant, the thermoplastic polymer or blend of thermoplastic polymers may further comprise liquid crystal polymers or cyclic polybutylene terephthalate, or mixtures containing same, such as the CBT100 resin marketed by Cyclics Corporation. These compounds make it possible in particular to fluidize the polymer matrix in the molten state, for a better penetration to the core of the fibers. Depending on the nature of the polymer, or blend of thermoplastic polymers, used for producing the pre-impregnation matrix, in particular its melting temperature, one or other of these compounds will be chosen.

The thermoplastic polymers that are incorporated into the composition of the pre-impregnation matrix of the fibrous material, may be chosen from:
polymers and copolymers from the family of aliphatic or cycloaliphatic polyamides (PAs) or semiaromatic PAs (also referred to as polyphthalamides (PPAs)),
PEBAs,
polyureas, in particular aromatic polyureas,
polymers and copolymers from the family of acrylics such as polyacrylates, and more particularly polymethyl methacrylate (PMMA) or derivatives thereof,
polymers and copolymers of the family of poly(aryl ether ketones) (PAEK) such as poly(ether ether ketone) (PEEK), or poly(aryl ether ketone ketones) (PAEKK) such as poly(ether ketone ketone) (PEKK) or derivatives thereof,
aromatic polyetherimides (PEIs),
polyaryl sulfides, in particular polyphenylene sulfides (PPSs),
polyaryl sulfones, in particular polyphenylene sulfones (PPSUs),
polyolefins, in particular polypropylene (PP),
polylactic acid (PLA),
polyvinyl alcohol (PVA),
fluoropolymers, in particular poly(vinylidene fluoride) (PVDF) or polytetrafluoroethylene (PTFE) or polychlorotrifluoroethylene (PCTFE), and blends thereof.

Advantageously, when said polymer is a blend of two polymers P1 and P2, the proportion by weight of polymer P1 and P2 is from 1-99% to 99-1%.

Advantageously, when said thermoplastic polymer is a blend, and the pre-impregnation process uses a dry powder, this blend is in the form of a powder obtained either by “dry blend” before introduction into the pre-impregnation tank or by “dry blend” carried out directly in the tank or by grinding of a compound carried out beforehand in an extruder.

Advantageously, this blend is composed of a powder obtained by “dry blend”, before introduction into the tank or directly in the tank, and this blend of two polymers P1 and P2 is a blend of PEKK and PEI.

Advantageously, the PEKK/PEI blend is from 90-10% to 60-40% by weight, in particular from 90-10% to 70-30% by weight.

The thermoplastic polymer may correspond to the non-reactive final polymer that will impregnate the fibrous material or to a reactive prepolymer, which will also impregnate the fibrous material, but is capable of reacting with itself or with another prepolymer, as a function of the chain ends borne by said prepolymer, after pre-impregnation, or else with a chain extender and in particular during heating at the level of the tension devices in the furnace and/or during the processing of the tape in the final process for manufacturing the composite part.

The expression “non-reactive polymer” means that the molecular weight is no longer likely to change significantly, that is to say that its number-average molecular weight (Mn) changes by less than 50% when it is processed and therefore corresponds to the final polyamide polymer of the thermoplastic matrix.

Conversely, the expression “reactive polymer” means that the molecular weight of said reactive polymer will change during the processing by reaction of reactive prepolymers with one another by condensation or substitution, or with a chain extender by polyaddition and without elimination of volatile by-products, so as to give the final polyamide polymer (non-reactive) of the thermoplastic matrix.

According to a first possibility, said prepolymer may comprise or consist of at least one reactive prepolymer (polyamide) bearing on the same chain (that is to say, on the same prepolymer) two end functions X′ and Y′ which functions are respectively coreactive with one another by condensation, more particularly with X′ and Y′ being amine and carboxyl or carboxyl and amine respectively. According to a second possibility, said prepolymer may comprise or consist of at least two polyamide prepolymers which are reactive with one another and which each respectively bear two end functions X′ or Y′, which are identical (identical for the same prepolymer and different between the two prepolymers), said function X′ of one prepolymer being able to react only with said function Y′ of the other prepolymer, in particular by condensation, more particularly with X′ and Y′ being amine and carboxyl or carboxyl and amine respectively.

According to a third possibility, said prepolymer may comprise or consist of at least one prepolymer of said thermoplastic polyamide polymer, bearing n reactive end functions X, chosen from: —NH₂, —CO₂H and —OH, preferably NH₂ and —CO₂H with n being 1 to 3, preferably from 1 to 2, more preferentially 1 or 2, more particularly 2 and at least one chain extender Y-A′-Y, with A′ being a hydrocarbon biradical, bearing 2 identical reactive end functions Y, which are reactive by polyaddition with at least one function X of said prepolymer al), preferably with a molecular weight of less than 500 and more preferentially of less than 400.

The number-average molecular weight Mn of said final polymer of the thermoplastic matrix is preferably within a range extending from 10 000 to 40 000, preferably from 12 000 to 30 000. These Mn values can correspond to inherent viscosities greater than or equal to 0.8, as determined in m-cresol according to the standard ISO 307:2007, but changing the solvent (use of m-cresol in place of sulfuric acid and the temperature being 20° C.).

Said reactive prepolymers according to the two options mentioned above have a number-average molecular weight Mn ranging from 500 to 10 000, preferably from 1000 to 6800, in particular from 2500 to 6800.

The Mns are determined in particular by calculation on the basis of the content of the end functions, determined by potentiometric titration in solution, and the functionality of said prepolymers. The weights Mn can also be determined by size exclusion chromatography or by NMR.

The nomenclature used to define polyamides is described in the standard ISO 1874-1:2011 “Plastics—Polyamide (PA) moulding and extrusion materials—Part 1: Designation”, in particular on page 3 (tables 1 and 2), and is well known to those skilled in the art.

The polyamide may be a homopolyamide or a copolyamide or a blend thereof. Advantageously, the prepolymers constituting the matrix are chosen from polyamides (PAs), in particular chosen from aliphatic polyamides, cycloaliphatic polyamides, and semiaromatic polyamides (polyphthalamides) optionally modified by urea moieties, and copolymers thereof, polymethyl methacrylate (PPMA) and copolymers thereof, polyetherimides (PEIs), polyphenylene sulfide (PPS), polyphenylene sulfone (PPSU), PVDF, poly(ether ketone ketone) (PEKK), poly(ether ether ketone) (PEEK), fluoropolymers such as poly(vinylidene fluoride) (PVDF).

For the fluoropolymers, it is possible to use a homopolymer of vinylidene fluoride (VDF of formula CH₂═CF₂) or a copolymer of VDF comprising by weight at least 50% by weight of VDF and at least one other monomer copolymerizable with the VDF. The content of VDF must be greater than 80% by weight, or even better at 90% by weight, to ensure a good mechanical strength and chemical resistance for the structural part, especially when it is subjected to thermal and chemical stresses. The comonomer may be a fluoromonomer such as for example vinyl fluoride.

For structural parts that have to withstand high temperatures, besides the fluoropolymers, use is advantageously made according to the invention of PAEKs (polyaryl ether ketones) such as poly(ether ketone)s (PEKs), poly(ether ether ketone) (PEEK), poly(ether ketone ketone) (PEKK), poly(ether ketone ether ketone ketone) (PEKEKK) or PAs having high glass transition temperature Tg.

Advantageously, said thermoplastic polymer is a polymer having a glass transition temperature such that Tg ≥80° C., notably ≥100° C., in particular ≥120° C., notably ≥140° C., or a semicrystalline polymer having a melting temperature Tm ≥150° C. Advantageously, said thermoplastic polymer of the matrix is a non-reactive thermoplastic polymer.

Advantageously, said at least one thermoplastic prepolymer is selected from polyamides, PEKK, PEI and a blend of PEKK and PEI.

Advantageously, said polyamide is chosen from aliphatic polyamides, cycloaliphatic polyamides and semiaromatic polyamides (polyphthalamides).

Advantageously, said aliphatic polyamide prepolymer is chosen from:
polyamide 6 (PA6), polyamide 11 (PA11), polyamide 12 (PA12), polyamide 66 (PA66), polyamide 46 (PA46), polyamide 610 (PA610), polyamide 612 (PA612), polyamide 1010 (PA1010), polyamide 1012 (PA1012), polyamide 11/1010 and polyamide 12/1010, or a blend thereof or a copolyamide thereof, and block copolymers, notably polyamide/polyether (PEBA), and said semiaromatic polyamide is a semiaromatic polyamide optionally modified by urea moieties, notably a PA MXD6 and a PA MXD10 or a semiaromatic polyamide of formula X/YAr, as described in EP 1 505 099, especially a semiaromatic polyamide of formula A/XT wherein A is chosen from a moiety obtained from an amino acid, a moiety obtained from a lactam and a moiety corresponding to the formula (Ca diamine).(Cb diacid), with a representing the number of carbon atoms of the diamine and b representing the number of carbon atoms of the diacid, a and b each being between 4 and 36, advantageously between 9 and 18, the (Ca diamine) moiety being chosen from linear or branched aliphatic diamines, cycloaliphatic diamines and alkylaromatic diamines and the (Cb diacid) moiety being chosen from linear or branched aliphatic diacids, cycloaliphatic diacids and aromatic diacids;

X.T denotes a moiety obtained from the polycondensation of a Cx diamine and terephthalic acid, with x representing the number of carbon atoms of the Cx diamine, x being between 6 and 36, advantageously between 9 and 18, especially a polyamide of formula A/6T, A/9T, A/10T or A/11T, A being as defined above, in particular a polyamide PA 6/6T, a PA 66/6T, a PA 61/6T, a PA MPMDT/6T, a PA PA11/10T, a PA 11/6T/10T, a PA MXDT/10T, a PA MPMDT/10T, a PA BACT/10T, a PA BACT/6T, PA BACT/10T/6T, PA BACT/10T/11, PA BACT/6T/11.

T corresponds to terephthalic acid, MXD corresponds to m-xylylenediamine, MPMD corresponds to methylpentamethylenediamine and BAC corresponds to bis(aminomethyl)cyclohexane.

Advantageously, the thermoplastic polymer is a semiaromatic polyamide.

Advantageously, the thermoplastic polymer is a semiaromatic polyamide chosen from a PA MPMDT/6T, a PA PA11/10T, a PA 11/6T/10T, a PA MXDT/10T, a PA MPMDT/10T, a PA BACT/10T, a PA BACT/6T, PA BACT/10T/6T, PA BACT/10T/11, PA BACT/6T/11.

### Regarding the Pre-Impregnation Step:

The pre-impregnation step as already indicated above is carried out in a fluidized bed.

Advantageously, the pre-impregnation is carried out in a fluidized bed, and one or more tension device(s)(E) is (are) present upstream of said system.

The fluidized bed pre-impregnation process is described in WO 2018/115736.

An example of a unit for implementing a manufacturing process without the heating step by means of at least one tension device is described in international application WO 2015/121583.

This system describes the use of a tank comprising a fluidized bed to carry out the pre-impregnation step and can be used within the context of the invention.

Advantageously, the tank comprising the fluidized bed is provided with at least one tension device (E′) which may be a compression roller.

It should be noted that the tension devices (E) and (E′) may be identical or different, whether in terms of material or shape and its characteristics (diameter, length, width, height, etc., depending on the shape).

However, the tension device (E′) is neither a heating device nor is it heated.

The step of pre-impregnation of the fibrous material is carried out by passing one or more rovings through a continuous pre-impregnation device, comprising a tank (20), fitted with at least one tension device (E′) and comprising a fluidized bed (22) of powder of said polymer matrix.

The powder of said polymer matrix or polymer is suspended in a gas G (air for example) introduced into the tank and flowing into the tank (20) through a hopper (21). The roving(s) is (are) circulated through this fluidized bed (22).

The tank may have any shape, especially cylindrical or parallelepipedal, in particular a rectangular parallelepiped or a cube, advantageously a rectangular parallelepiped.

The tank (20) can be an open or closed tank. Advantageously, it is open.

In the case where the tank is closed, it is then equipped with a sealing system so that the powder of said polymer matrix cannot leave said tank.

This pre-impregnation step is therefore carried out by a dry route, that is to say that the thermoplastic polymer matrix is in powder form, especially in suspension in a gas, in particular air, but cannot be in dispersion in a solvent or in water.

Each roving to be pre-impregnated after passing over the tension devices (E) goes into a tank (20)

The fiber roving or parallel fiber rovings then goes or go into a tank (20), comprising in particular a fluidized bed (22), fitted with at least one tension device (E′) which is a compression roller or is already present in the tank and then enters the fluidized bed (22), fitted with at least one tension device (E′).

The fiber roving or parallel fiber rovings then emerge(s) from the tank after pre-impregnation after optional controlling of the residence time in the powder.

In one embodiment, the process according to the invention comprises a step of heating the pre-impregnated fibrous material to melt the thermoplastic polymer of the matrix and to finalize the impregnation of said fibrous material.

Said heating step can be performed as described in WO 2018/234439:

A first heating step can immediately follow the pre-impregnation step or else other steps can occur between the pre-impregnation step and the heating step.

Advantageously, said first heating step immediately follows the pre-impregnation step. The expression “immediately follow” means that there is no intermediate step between the pre-impregnation step and said heating step.

Advantageously, a single heating step is carried out immediately following the pre-impregnation step.

Advantageously, said at least one heating system is chosen from an infrared lamp, a UV lamp and convection heating.

Since the fibrous material is in contact with the tension device(s) in the heating system, and the tension device is conductive, the heating system is therefore also performed by conduction.

Advantageously, said at least one heating system is chosen from an infrared lamp.

Advantageously, said at least one tension device (E″) is a compression roller of convex, concave or cylindrical shape.

It should be noted that the compression rollers corresponding to the tension devices (E), (E′) and (E″) may be identical or different, whether in terms of material or shape and its characteristics (diameter, length, width, height, etc., depending on the shape).

The convex shape is favorable to the spreading whereas the concave shape is unfavorable to the spreading although it is nevertheless carried out.

The at least one tension device (E″) can also have a shape that alternates between convex and concave. In that case, the running of the roving on a compression roller of convex shape causes the spreading of said roving and then the running of the roving on a compression roller of concave shape causes the retraction of the roving and so on, making it possible if necessary to improve the uniformity of the impregnation, in particular to the core.

The expression “compression roller” means that the roving that is running presses partially or completely against the surface of said compression roller, which induces the spreading of said roving.

The rollers can be free (rotating) or fixed.

They can be smooth, ribbed or grooved.

Advantageously, the rollers are cylindrical and ribbed. When the rollers are ribbed, two ribs may be present in opposite directions from each other starting from the center of said roller, thus allowing the rovings to be moved away toward the outside of the roller, or in opposite directions from one another starting from the outside of said roller, thus making it possible to bring the locks toward the center of the roller.

This heating step makes it possible to make the pre-impregnation uniform, to thus finalize the impregnation and to thus have a core impregnation and to have a high content of fibers by volume, in particular constant in at least 70% of the volume of the strip or ribbon, notably in at least 80% of the volume of the strip or ribbon, in particular in at least 90% of the volume of the strip or ribbon, more particularly in at least 95% of the volume of the strip or ribbon, and also to decrease the porosity.

The spreading depends on the fibrous material used. For example, the spreading of a carbon fiber material is much greater than that of a flax fiber.

The spreading also depends on the number of fibers in the roving, on their average diameter and on their cohesion due to the size.

The diameter of said at least one compression roller (tension device (E″)) is from 3 mm to 100 mm, preferentially from 3 mm to 20 mm, in particular from 5 mm to 10 mm.

Below 3 mm, the deformation of the fiber induced by the compression roller is too large.

Advantageously, the compression roller is cylindrical and non-grooved and in particular is metallic.

Advantageously, said at least one tension device (E″) consists of at least one compression roller of cylindrical shape.

Advantageously, said at least one tension device (E″) consists of from 1 to 15 compression rollers (R1 to R15) of cylindrical shape, preferably from 3 to 15 compression rollers (R3 to R15), in particular from 6 to 10 compression rollers (R6 to R10).

It is quite obvious that whatever the number of tension devices (E″) present, they are all located or included in the environment of the heating system, that is to say that they are not outside the heating system.

According to another aspect, the present invention relates to the use of the process as defined above, for the manufacture of calibrated ribbons suitable for the manufacture of three-dimensional composite parts, by automated layup of said ribbons using a robot.

Advantageously, said composite parts relate to the fields of transport, in particular motor vehicle transport, of oil and gas, in particular offshore, of hydrogen, of gas storage, in particular hydrogen, aeronautical, nautical and railroad transport; of renewable energy, in particular wind turbine or marine turbine, energy storage devices, solar panels; thermal protection panels; sports and leisure, health and medical, and electronics.

According to another aspect, the present invention relates to a three-dimensional composite part, characterized in that it results from the use of the process as defined above.

According to yet another aspect, the present invention relates to a tank (20) comprising a fluidized bed (22), a scraper or a transverse suction system which sucks up fine particles for use in a process as defined above.

According to yet another aspect, the present invention relates to a tank (20) comprising a fluidized bed (22), a scraper and a transverse suction system which sucks up fine particles for use in a process as defined above.

### BRIEF DESCRIPTION OF THE FIGURES

FIG. 1 presents a partial diagram of a unit for implementing the process for manufacturing a pre-impregnated fibrous material according to WO 2018/115736.

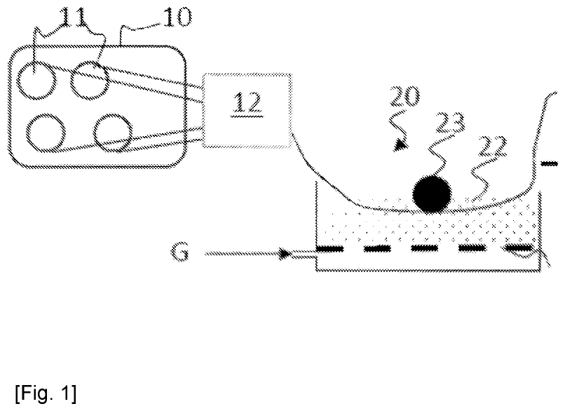

FIG. 2 presents a tank comprising a fluidized bed provided with at least one tension device (E′) which may be a compression roller.

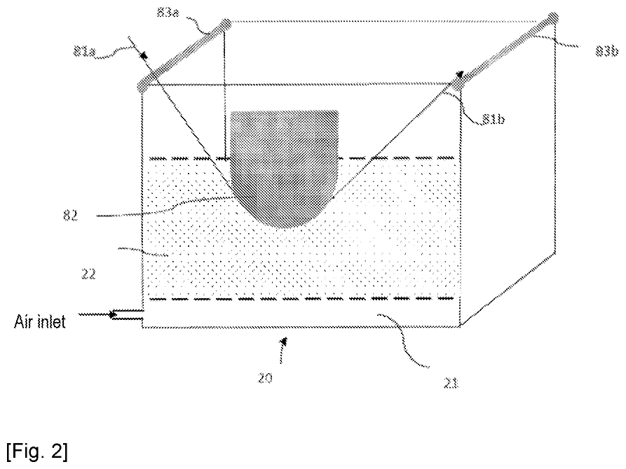

FIG. 3 presents a photo of the tank with a scraper.

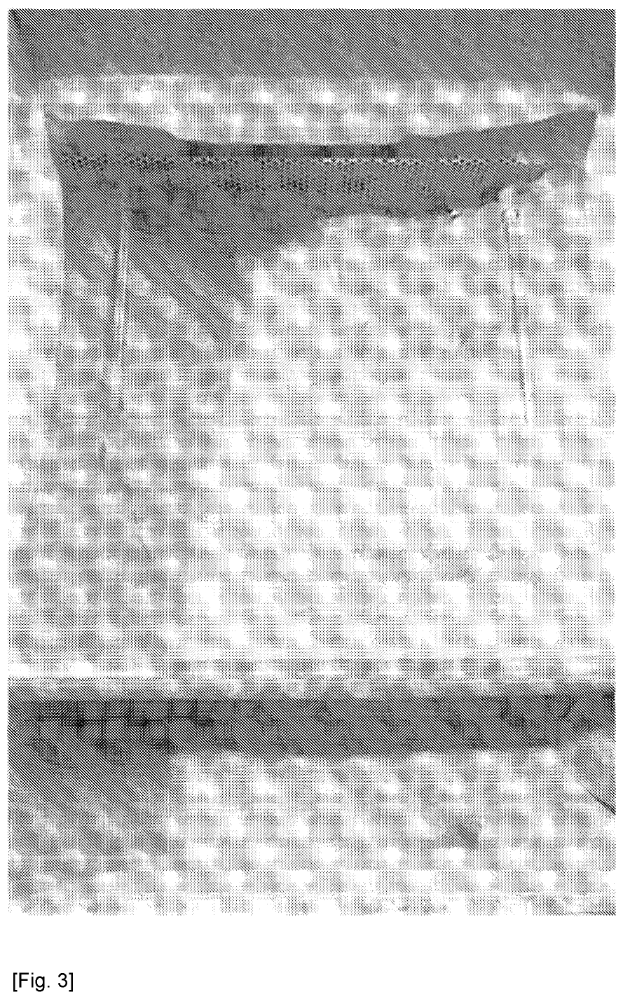

FIG. 4 is the presentation of the automated scraper system for the fuzz and the unpacking of the powder over time. The fuzz is automatically recovered in an inoperative area of the tank that does not disrupt the rest of the tank. FIG. 4 and FIG. 5 below are only one figure, but for visibility reasons, it has been split into two parts; FIG. 4 represents the left part and FIG. 5 represents the right part.

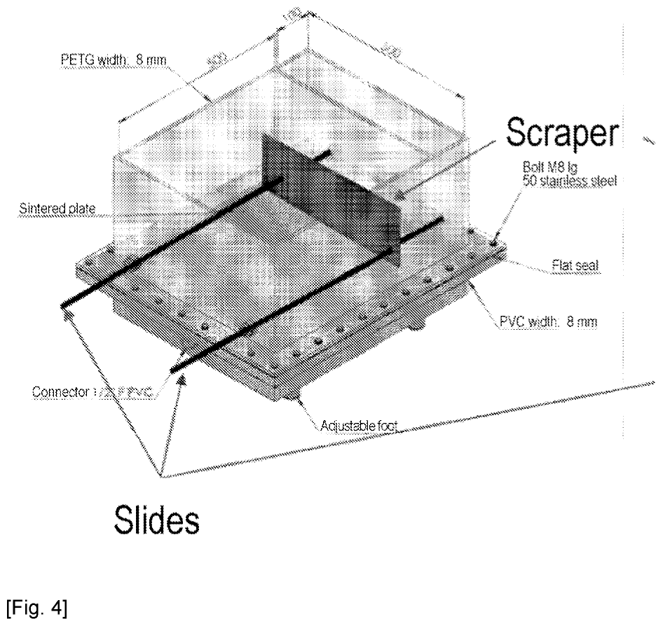

FIG. 5 is the right part as explained above.

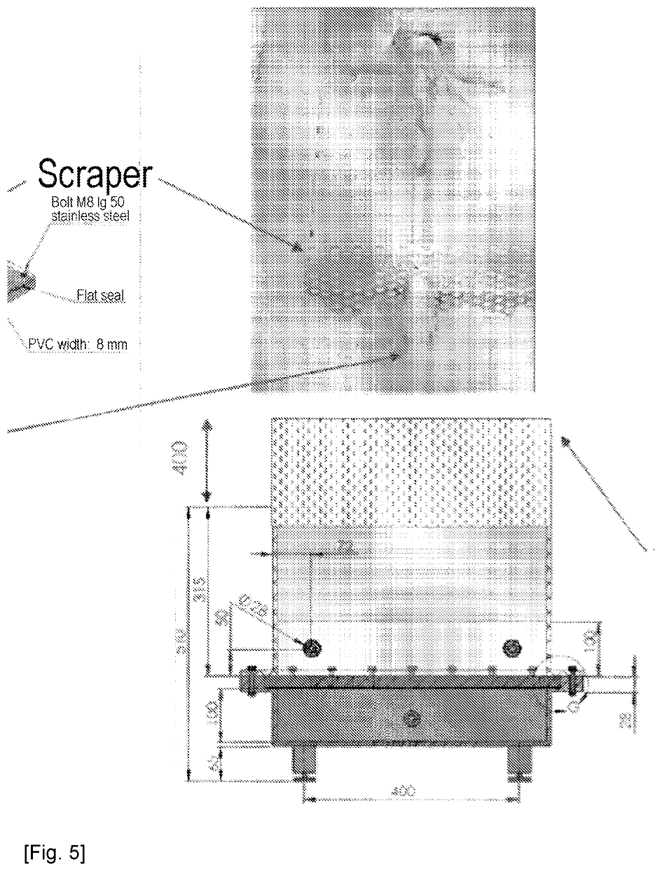

FIG. 6 presents a cyclone making it possible to recover the powders sucked up above the fluidized bed.

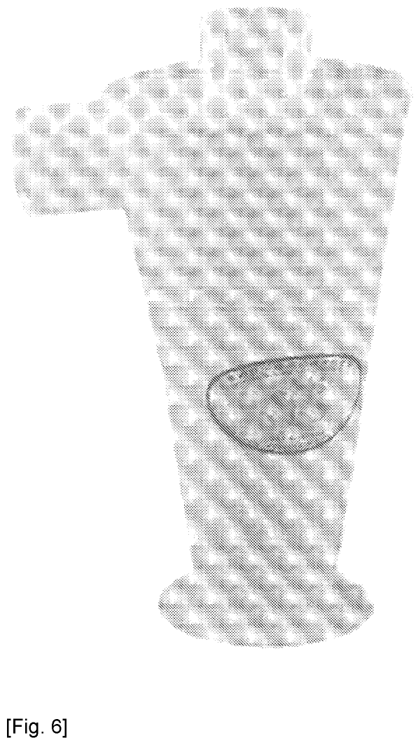

FIG. 7 shows the decrease in the level of the fluidized bed and the percentage by weight of thermoplastic polymer (BACT/10T) in the fibrous material AS4 from Hexcel as a function of time. Left scale: bed height Right scale: weight in % of thermoplastic polymer (BACT/10T).

### EXAMPLES

### Example 1

A production test was carried out on a pilot line for the pre-impregnation of an AS4 12k fibrous material from Hexcel with a BACT/10T thermoplastic polymer matrix having a particle size of D50=106 μm in a transparent parallelepipedal tank with dimensions L×l×h=500×500×400 mm³, only adding powder manually as the pre-impregnation progresses. The powder added has a particle size equal to that in the tank at the start. This situation is therefore the worst-case scenario, in which nothing in terms of particle size is controlled or readjusted.
4 families of powders are obtained, the particle sizes of which may be analyzed:
   the one carried away by the fibrous material and the particle size distribution of which is substantially equivalent to that present in the tank→G0
   the one that flies away and falls back down next to the tank and the one that is carried away by the fibrous material and falls from the fibrous material before being melted→G1
   the one initially present in the tank→G2
   the one present in the tank at the end of production→G3

After 1 week of production, the volume of powder of particle size G1 found next to the tank was measured as equal to 1/20 of that of the volume of powder initially present in the tank.

After 1 week of production, the following table is thus obtained:

TABLE 1

| | | D10 | D50 | D90 |
|---|---|---|---|---|
| | G0 | 27 | 110 | 268 |
| | G1 | 36 | 147 | 294 |
| | G2 | 27 | 110 | 268 |
| | G3 | 87 | 191 | 333 |
| Without recycling this gives | Difference G3&G2 | 69% | 42% | 20% |

With recycling, a G4 particle size is obtained in the tank substantially equivalent to G0.

### Example 2

Tank with automated scraper and automatic system for supplying the powder during production.

Fiber material: carbon fiber AS4 12k from Hexcel

Thermoplastic polymer: BACT/10T (40/60 in molar percentage) having a Tg of 140° C. and a particle size D50=106 μm.

Raking is carried out with the scraper every 15 minutes, which makes it possible to return to the initial bed height and to maintain the amount of BACT/10T carried away without adding powder for 1 h 40, thereby making it possible to recover the generated fuzz which accumulates at the surface of the frit.

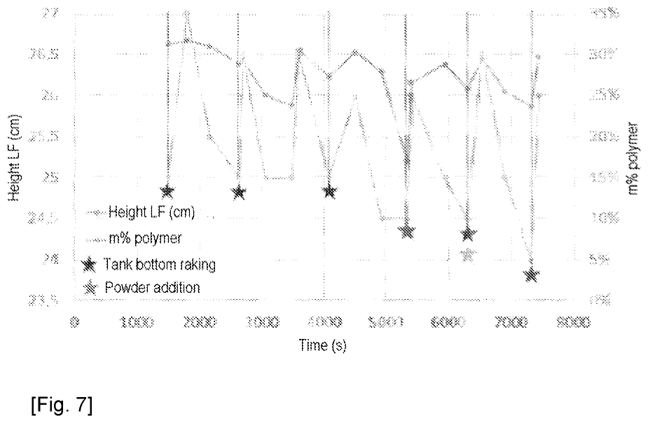

The results are presented in FIG. 7.

1. A process for manufacturing an impregnated fibrous material comprising at least one fibrous material made of continuous fibers and at least one thermoplastic polymer matrix, said process comprising:
a step of pre-impregnating said fibrous material with a thermoplastic polymer matrix in powder form, wherein said pre-impregnation step is carried out dry in a tank comprising a fluidized bed, said pre-impregnation step being carried out while keeping the level h of the powder and the mass m of the powder present in the tank substantially constant, said level h being from hi to hi−3% during an implementation of the pre-impregnation step, where hi is an initial level of the powder in said tank at a start of the implementation of the pre-impregnation step, said mass m being from mi to mi±0.5% during the implementation of the pre-impregnation step, where mi is an initial mass of the powder in said tank at the start of the implementation of the pre-impregnation step,
with the exclusion of any electrostatic process with intentional charging.

2. The process as claimed in claim 1, wherein a volume mean diameter D50 of thermoplastic polymer powder particles of the powder is from 30 to 300 μm.

3. The process as claimed in claim 1, wherein the tank is replenished with the thermoplastic polymer matrix in powder form to compensate for a consumption of said thermoplastic polymer matrix by the pre-impregnation of said fibrous material.

4. The process as claimed in claim 1, wherein a particle size of said powder is substantially constant in said tank, such that a D50 of the thermoplastic polymer powder particles of the powder varies by a maximum of +20%.

5. The process as claimed in claim 1, wherein a particle size of the fine particles of said powder is substantially constant in said tank, such that a D10 of the thermoplastic polymer powder particles of the powder varies by a maximum of +30%.

6. The process as claimed in claim 1, wherein a particle size of the large particles of said powder is substantially constant in said tank, such that a D90 of the thermoplastic polymer powder particles of the powder varies by a maximum of +10%.

7. The process as claimed in claim 1, wherein said tank comprises a fluidized bed and said pre-impregnation step is carried out with simultaneous spreading of a roving or rovings between an inlet and an outlet of said fluidized bed.

8. The process as claimed in claim 1, wherein said tank is equipped with a scraper.

9. The process as claimed in claim 8, wherein said scraper is used automatically when the level h<hi−3%.

10. The process as claimed in claim 1, wherein said tank is equipped with a transverse suction system which sucks up fine particles having a diameter of 0.01 to 60 μm which leave said tank during the fluidization.

11. The process as claimed in claim 10, wherein said suctioned particles are continuously reintroduced into said tank.

12. The process as claimed in claim 1, wherein said tank is equipped with a scraper and a transverse suction system which sucks up fine particles having a diameter of 0.01 to 60 μm which leave said tank.

13. The process as claimed in claim 1, wherein said fluidized bed comprises at least one tension device, a roving or rovings being in contact with a portion or the whole of a surface of said at least one tension device.

14. The process as claimed in claim 13, wherein a spreading of said roving or of said rovings is carried out at least at a level of said at least one tension device.

15. The process as claimed in claim 13, wherein said at least one tension device is a compression roller of convex, concave or cylindrical shape.

16. The process as claimed in claim 15, wherein said at least one compression roller is of cylindrical shape and a percentage of spreading of said roving or of said rovings between the inlet and the outlet of said fluidized bed is from 1% to 400%.

17. The process as claimed in claim 1, wherein said thermoplastic polymer is a non-reactive thermoplastic polymer.

18. The process as claimed in claim 17, comprising a step of heating the pre-impregnated fibrous material to melt the thermoplastic polymer and to finalize the impregnation of said fibrous material.

19. The process as claimed in claim 1, wherein said thermoplastic polymer is a reactive prepolymer capable of reacting on itself or with another prepolymer, depending on the chain ends borne by said prepolymer, or else with a chain extender.

20. The process as claimed in claim 19, comprising a step of heating the pre-impregnated fibrous material to melt and polymerize the thermoplastic prepolymer optionally with said extender and to finalize the impregnation of said fibrous material.

21. The process as claimed in claim 1, wherein said at least one thermoplastic polymer is selected from: poly(aryl ether ketone)s (PAEKs), in particular poly(ether ether ketone) (PEEK); poly(aryl ether ketone ketone)s (PAEKKs), in particular poly(ether ketone ketone) (PEKK); aromatic polyetherimides (PEIs); polyaryl sulfones, in particular polyphenylene sulfones (PPSUs); polyaryl sulfides, in particular polyphenylene sulfides (PPSs), polyamides (PAs), in particular semiaromatic polyamides (polyphthalamides) optionally modified by urea moieties; PEBAs, polyacrylates, in particular polymethyl methacrylate (PMMA); polyolefins, in particular polypropylene, polylactic acid (PLA), polyvinyl alcohol (PVA), and fluoropolymers, in particular polyvinylidene fluoride (PVDF) or polytetrafluoroethylene (PTFE) or polychlorotrifluoroethylene (PCTFE); and blends thereof.

22. The process as claimed in claim 1, wherein said at least one thermoplastic polymer is a polymer having a glass transition temperature such that Tg≥80° C., or a semicrystalline polymer having a melting temperature Tm≥150° C.

23. The process as claimed in claim 1, wherein said at least one thermoplastic polymer is selected from polyamides, aliphatic polyamides, cycloaliphatic polyamides and semiaromatic polyamides (polyphthalamides), PEKK, PEI and a blend of PEKK and PEI.

24. The process as claimed in claim 1, wherein a content of fibers in said impregnated fibrous material is from 45% to 65% by volume.

25. The process as claimed in claim 1, wherein a degree of porosity in said impregnated fibrous material is less than 10%.

26. The process as claimed in claim 1, wherein said thermoplastic polymer further comprises carbon-based fillers.

27. The process as claimed in claim 1, wherein said fibrous material comprises continuous fibers selected from carbon fibers, glass fibers, silicon carbide fibers, basalt-based or basalt fibers, silica fibers, natural fibers in particular flax or hemp fibers, lignin fibers, bamboo fibers, sisal fibers, silk fibers, or cellulose fibers in particular viscose fibers, or amorphous thermoplastic fibers having a glass transition temperature Tg above the Tg of said polymer or of said blend of polymers when the latter is amorphous or above the Tm of said polymer or of said blend of polymers when the latter is semicrystalline, or semicrystalline thermoplastic fibers having a melting temperature Tm above the Tg of said polymer or of said blend of polymers when the latter is amorphous or above the Tm of said polymer or of said blend of polymers when the latter is semicrystalline, or a mixture of two or more of said fibers.

28. The process as defined in claim 1, performed for manufacture of calibrated ribbons suitable for manufacture of three-dimensional composite parts, by automated layup of said ribbons using a robot.

29. The process as claimed in claim 28, wherein said composite parts relate to any of the fields of transport, of oil and gas, of hydrogen, of gas storage, aeronautical, nautical and railroad transport; or of renewable energy, energy storage devices, solar panels; or thermal protection panels; sports and leisure, health and medical, and electronics.

30. A three-dimensional composite part, which results from the process as defined in claim 28.

31. A tank comprising a fluidized bed, and a scraper or a transverse suction system configured to suck up fine particles, configured for use in a process as defined in claim 1.

32. A tank comprising a fluidized bed, a scraper and a transverse suction system configured to suck up fine particles, configured for use in a process as defined in claim 1.
